(19) United States
(12) Patent Application Publication
(10) Pub. No.: US 2005/0277428 A1
(43) Pub. Date: Dec. 15, 2005

(54) Location-based control of wireless communications device features

(75) Inventor: Joe Nathan Brown, Austin, TX (US)

Correspondence Address: Andrew M. Harris;Weiss, Moy & Harris, P.C., 4204 North Brown Ave., Scottsdale, AZ, 85251-3914, US

(73) Assignee: International Business Machines Corporation, Armonk, NY (US)

(21) Appl. No.: 10/845,564

(22) Filed: May 13, 2004

(51) Int. Cl. H04Q 7/20

(52) U.S. Cl. 455/456.3

(57) ABSTRACT

A method, system and wireless communications device providing location-based control of wireless communications device features provides security and nuisance avoidance for persons or organizations controlling particular areas in which the devices are not desirable for use. The location of the device is determined by triangulation or via communication of location information from the device, such as GPS information. The services provider determines whether or not the devices are within a controlled area for which features of the device are to be disabled, and disables those features if the device is in such a zone. The service provider maintains a database of zone coordinates and feature sets to disable for each zone. Features that may be disabled include: cameras, text messaging, ringers and/or voice communications. The service provider may also entirely disable a device when the device is located within a particular zone.

### BACKGROUND OF THE INVENTION

1. Field of the Invention

The present invention is related to wireless communication systems and devices, and more particularly to control of wireless communication device features based on the location of the wireless telephone.

2. Description of Related Art

Wireless telephones and other wireless devices such as pagers and personal digital assistants (PDAs) are in widespread use. Recently, the above-mentioned devices have been adapted to include graphic displays, cameras and other peripheral features that provide the ability to communicate visual information. Detection of the use of visual features, such as the use of the camera on a wireless telephone, is not generally detectable unless an audible output is produced from the camera or a person is observed using the camera. The audible output produced by some wireless devices when the camera is used can be masked or defeated, thus rendering camera use undetectable except by observation of the user.

Secure areas containing sensitive data and other areas in which use of photographic equipment is not permitted, are difficult to control in light of recent inclusion of visual peripherals in wireless devices. Several techniques have been employed to disable wireless devices entirely, such as radio-frequency (RF) transmissions that essentially jam the wireless device signals. Such jamming is not permitted in some countries or in some frequency bands, and therefore does not provide an effective universal solution to the problem of unauthorized use of visual peripherals on a wireless device.

Location systems for providing the location of wireless devices have recently been implemented for all wireless telephones and are also being implemented for other wireless devices. Due to the need to locate wireless telephones for emergency services such as “911” emergency services, the availability of location information for a connected wireless device has been mandated by law. Such information is now generally available at the wireless service provider facilities, and in some cases is available at the wireless devices.

Further, the use of other features of a wireless device require management in other areas where feature use is not desirable or may generate a nuisance. For example in restaurants and classrooms, the ringing or use of a wireless telephone are typically undesirable, and to-date only the above-mentioned jamming systems or signaling methods are typically employed.

Therefore, it would be desirable to provide a method and system for wireless device control that makes use of a location infrastructure provided by wireless systems providers in order to manage the use of wireless device features in certain areas. It would further be desirable to provide a service that may be sold by the providers that benefits organizations and persons attempting to manage the use of wireless device features in areas they control.

### SUMMARY OF THE INVENTION

The above objectives of providing location-based wireless device control and a service for such control are implemented in a method, system and wireless device that selectively disable features of a wireless device in response to a determination that the wireless device is located in a controlled area.

The system determines the location of a wireless device by determining multiple times of arrival of signals received by the system from the wireless device and triangulating a physical position of the wireless device. Alternatively, the wireless provider receives location information from the wireless device itself, via global positioning system (GPS) information received by the wireless device, or other location finding mechanism.

The determined location is then compared to a database of controlled areas and if the wireless device is located in a given one of the controlled areas, one or more features of the wireless device is disabled until the location of the wireless device is outside of the given area. The database may further include a feature specifier for each controlled area, so that one or more features are disabled in conformity with the specifier for the given area.

Features that may be disabled in controlled areas include, but are not limited to: cameras, text messaging, sound (ringer) and voice communications.

The method may be embodied in a wireless network control system computer executing program instructions for carrying out the steps of the method and may further be embodied in a computer program product containing program instructions in computer-readable form for carrying out the steps of the method. The method or portions thereof may also be embodied within a wireless device that receives location information and controlled area information, or a signal that indicates that the wireless device is in a controlled area. The wireless device then disables features in conformity with the received information.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram of a wireless communications system in which methods in accordance with an embodiment of the present invention are performed.

FIG. 2 is a block diagram of a wireless communications system in accordance with an embodiment of the present invention.

FIG. 3 is a flow chart of a method in accordance with an embodiment of the present invention.

### DETAILED DESCRIPTION OF PREFERRED EMBODIMENT

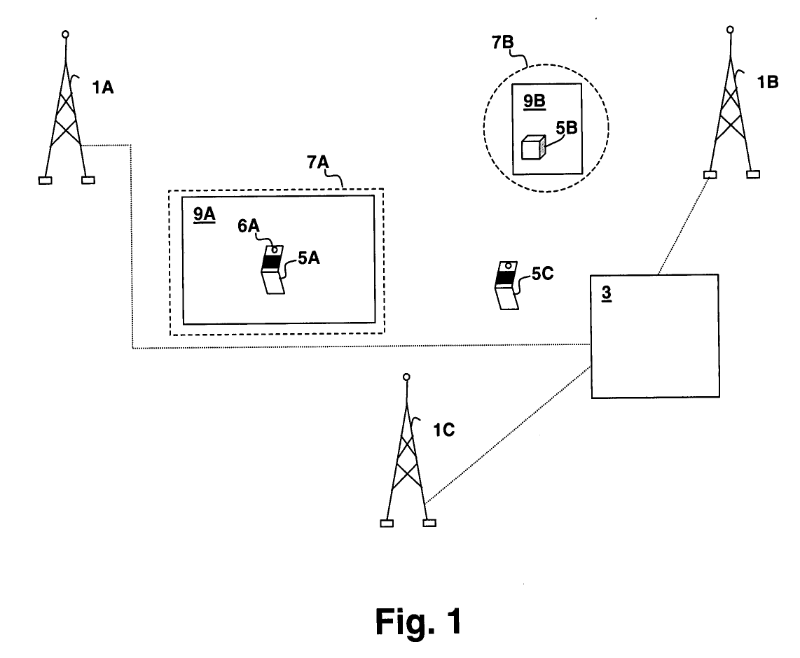

Referring to the figures, and particularly to FIG. 1, a wireless communication system in accordance with an embodiment of the present invention is depicted. Wireless devices 5A-5C are located within the range of wireless network stations 1A-1C which support wireless communications between wireless devices 5A-5C and other devices connected via wide area network and/or telephone network with wireless network stations 1A-1C. In particular, wireless network stations 1A-1C may be digital mobile telephone or analog cellular telephone stations. Wireless network stations 1A-1C are further coupled via wired or wireless connections to central station 3, shown in the illustrative embodiment as a central station that controls wireless services provided to wireless devices 5A-5C. However, the techniques of the present invention are equally applicable to a distributed “hand-off” control architecture, where control of the wireless services provided at the primary wireless network station (generally the closest to a particular wireless device) that is providing communications service to and from the particular wireless device.

In accordance with an embodiment of the present invention, central station 3 selectively disables features of particular wireless devices in response to determining that the particular wireless devices are located in controlled areas, for example areas 7A and 7B. Area 7A is shown as a rectangular zone surrounding a museum 9A that has contracted with the wireless service provider to disable the use of cameras attached to mobile telephones and other devices such as personal digital assistants (PDAs), so that museum-goers cannot photograph exhibits in and around museum 9A. Central station 3 has disabled camera 6A on mobile telephone 5A so that camera 6A may not be used in and around museum 9A.

Area 7B is a circular zone surrounding a lecture hall 9B within a university. The university has contracted with the wireless service provider to disable ringers on mobile telephones and pagers, disable text messaging services and cameras within lecture hall 9B, in order to avoid transmission of examination-related information to or from the lecture hall 9B, as well as preventing ringers from interrupting lectures. In the example, central station 3 has disabled ringing and text messaging services to pager 5B.

Although such a zone is not illustrated in the figure, zones may also be implemented that disable voice communications, or essentially all features of a wireless device, for example in high security areas, where any form of unauthorized communication outside of a facility is undesirable. The shape of the zones may be circular, rectangular or any other shape that may be defined, dependent on the resolution of the location information available from the location-determining mechanism. Mobile telephone 5C is shown outside of any defined zone, and therefore all services available to mobile telephone 5C are enabled as well as all controllable features of mobile telephone 5C.

The location of wireless devices 5A-5C can be determined in a variety of manners as are well known in the art. As an illustrative example, wireless network stations 1A-1C are configured as receivers capable of triangulating signals received from wireless devices 5A-5C. At each wireless network station 1A-1C, a time of arrival (TOA) is measured and the TOA information communicated to central station 3. Central station determines the differences between time of arrivals at each wireless station 1A-1C and solves for the intersection of the constant time difference hyperbolas defined around each station 1A-1C.

Alternatively, a timebase and TOA counter set within wireless devices 5A-5C may provide location information via triangulating signals transmitted from stations 1A-1C that include transmission time information and location information for each of the stations. However, in general, it is more practical to implement location services from triangulation by the system rather than including the TOA measurement electronics and algorithms within the connected devices.

Also alternatively, one or more of wireless devices 5A-5C may include a position determining mechanism such as a global positioning system (GPS) receiver and can therefore transmit location information to central station 3 via one or more of wireless network stations 1A-1C. Central station 3 then uses the location information transmitted from a wireless device to determine whether or not the wireless device is located within a controlled area for which features of the wireless device should be disabled.

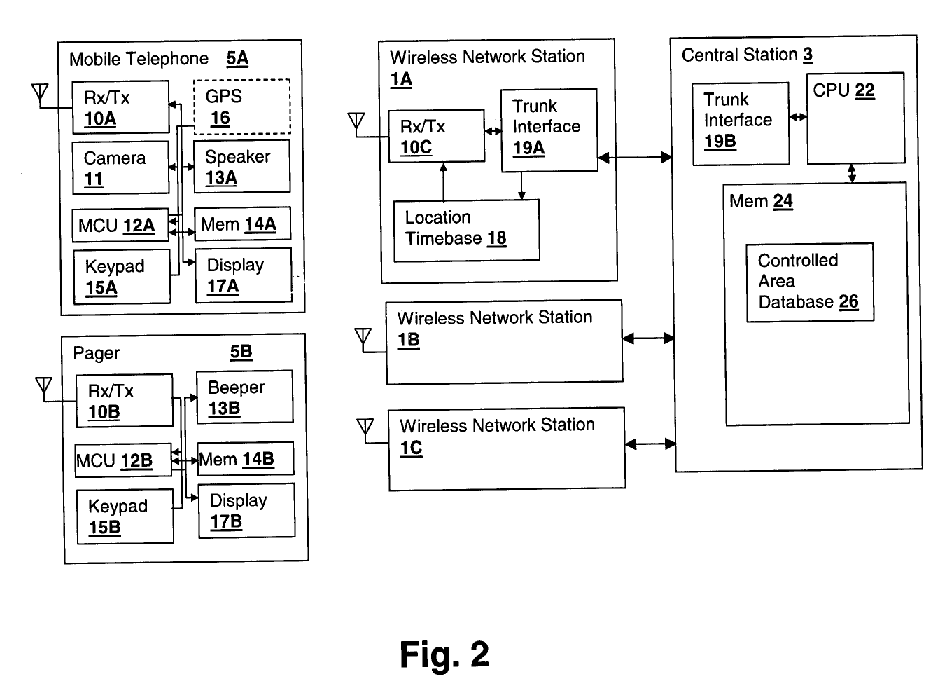

Referring now to FIG. 2, details of the wireless network depicted in FIG. 1 are shown in block diagram form. Mobile telephone 5A includes a variety of features controllable by the methods in accordance with embodiments of the present invention. Features of mobile telephone 5A include a speaker 13A that is used for generating a ringing tone and audible voice output (optionally two speakers are used, one for ringing and one for voice). Other features include a display 17A, a keypad 15A and a camera 11. Each of the above features is interfaced to a microcontroller unit (MCU) 12A that is coupled to a memory 14A for providing control of mobile telephone 5A. A transmit/receive unit 10A is coupled to MCU 12A for providing communications with wireless network stations 1A-1C. An optional GPS receiver 16 is coupled to MCU 12A to provide location in formation locally within mobile telephone 5A as an alternative to, or in conjunction with triangulation location-finding within the wireless network.

Memory 14A includes program instructions for execution by MCU 12A including interpretation of commands received from the wireless network via transmit/receive unit 10A. Commands to enable and disable features locally within wireless telephone 5A are implemented in order to control features that cannot be disabled directly by the service provider at central station 3 and/or wireless network stations 1A-1C. For example, disabling ringing completely may be achieved by not sending calls to mobile telephone 5A, but in order to disable ringing through speaker 13A, while maintaining silent ringing via a flashing of display 17A or a vibration device (not shown), local use of speaker 13A is disabled via a command sent to mobile telephone 5A. Other local disable commands are commands to disable local use of camera 11, such as for disabling a recording function vs. service disabling of camera data sent to another location.

Pager 5B operates and is controlled in a manner similar to that of mobile telephone 5A. Features of pager 5B include a beeper 13B that is used for indicating an incoming page. Other features include a text-messaging and page number display 17B along with a text-messaging and control keypad 15B. Each of the above features is interfaced to an MCU 12B that is coupled to a memory 14B for providing control of pager 5B. A transmit/receive unit 10B is coupled to MCU 12B for providing communications with wireless network stations 1A-1C. Memory 14B includes program instructions for execution by MCU 12B including interpretation of commands received from the wireless network via transmit/receive unit 10B. Commands to enable and disable features locally within pager 5B are implemented in order to control features that cannot be disabled directly by the service provider at central station 3 and/or wireless network stations 1A-1C. For example, disabling pages completely may be achieved by not sending pages to pager 5B, but in order to disable beeper 13B, while maintaining silent paging via a flashing of display 17B or a vibration device (not shown), local use of beeper 13B is disabled via a command sent to pager 5B.

Table I below illustrates an exemplary control scheme for disabling features of a wireless device according to system or local control.

TABLE I

| | | Control at | Control at |
|---|---|---|---|
| Feature | Application | Service | device |
| Camera | block | X | |
| | transmission of | | |
| | visual | | |
| | information | | |
| Camera | block gathering | | X |
| | of visual | | |
| | information | | |
| Ringer | Stop audible | | X |
| | nuisance | | |
| Call service | Stop usage | X (either) | X (either) |
| | nuisance/block | | |
| | transmission of | | |
| | information by | | |
| | voice | | |
| Text Messaging | Stop | X (either) | X (either) |
| | transmission/ | | |
| | reception of text | | |
| | information | | |

The system also includes wireless network stations 1A-1C, that include subsystems as illustrated in detail for wireless network station 1A. Each station 1A-1C includes a transmit/receive subsystem 10C, a location timebase 18, which provides time stamping reference for time-of-arrival of signals from wireless devices, which are identified by a unique identifier, permitting stations 1A-1C to communicate time-of-arrival, command/data and identification information for each wireless device to central station 3 via a trunk interface 19A.

Central station 3 includes a trunk interface 19B that provides connection to stations 1A-1C and is coupled to a processor 22 that is coupled to a memory 24 that contains program instructions and data for providing control of the system and location computation for each device. Memory 24, in particular contains a controlled area database 26 that contains at least sets of coordinates defining the controlled areas and sets of features to disable within the controlled areas. Processor 22, thereby determines when a wireless device is within a controlled area and sends commands to the wireless device to disable features and/or suspends providing particular service features to the wireless device.

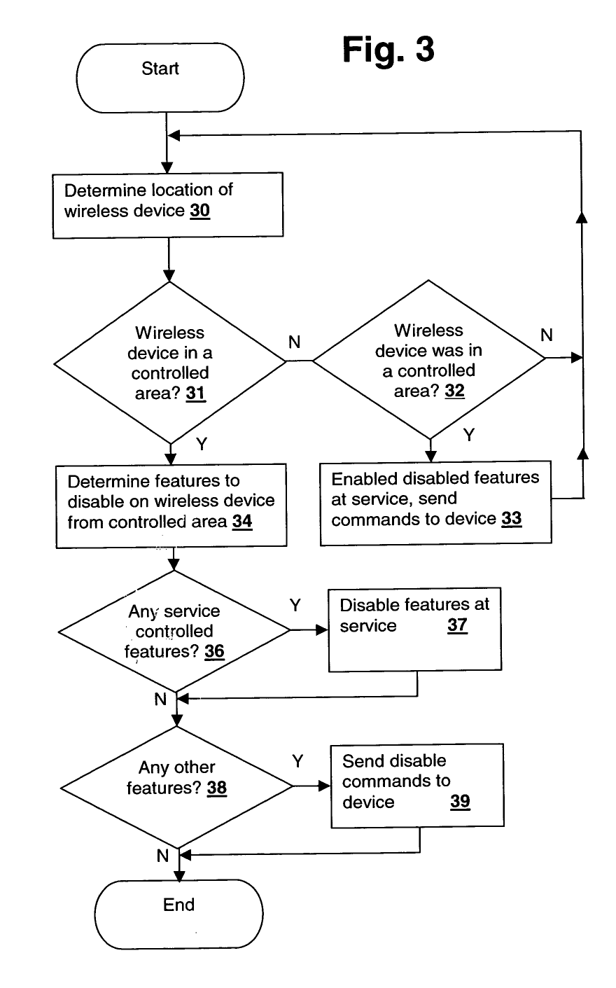

Referring now to FIG. 3, a flowchart of a method in accordance with an embodiment of the present invention. First, the location of a wireless device is determined (step 30), either by triangulation of signals from the wireless device, or by receiving location information from the wireless device. Next, if the wireless device is within a controlled area (decision 31), as determined by a search of database 26 and comparison of the location of the wireless device with the coordinates of each controlled area, then the set of features to disable on the wireless device is determined (step 34) by looking up feature disable parameters in database 26. If any service-controlled features are to be disabled (decision 36), then the features are stopped at the service (step 37). If any other features are to be disabled (decision 38), commands are sent to the wireless device to disable the features locally (step 39).

If the wireless device is leaving a controlled area as indicated by (decision 31) indicating that the device is not in a controlled area and a test that determines if the wireless was in a controlled area (decision 32). Services that were suspended to disable features of the wireless device are resumed and commands are sent to the wireless device if features were disabled locally (step 33).

While the invention has been particularly shown and described with reference to the preferred embodiments thereof, it will be understood by those skilled in the art that the foregoing and other changes in form, and details may be made therein without departing from the spirit and scope of the invention.

1. A method for controlling features of a wireless device coupled to a wireless network, the method comprising:
determining a location of said wireless device;
second determining whether or not said location is within a controlled area, said controlled area being a geographical area designated for which use of a feature of said wireless device is not allowed; and
responsive to determining that said location is within said controlled area, disabling said feature of said wireless device.

2. The method of claim 1, wherein said wireless device includes a camera, and wherein said disabling disables operation of said camera.

3. The method of claim 1, further comprising third determining said feature in conformity with a result of said second determining.

4. The method of claim 1, wherein said second determining further determines whether or not said feature is a feature controlled locally within said wireless device, and wherein said disabling comprises:
sending a command to said wireless device from said wireless network in response to determining that said feature is controlled locally; and
disabling said feature within said wireless device in response to said command.

5. The method of claim 1, wherein said second determining further determines whether or not said feature is a feature provided by a service of said wireless network, and wherein said disabling comprises suspending said service in response to determining that said feature is provided by said service.

6. The method of claim 1, further comprising:
subsequent to said disabling, determining whether or not said wireless device has left said controlled area; and
responsive to determining that said wireless device has left said controlled area, enabling said feature of said wireless device.

7. The method of claim 1, wherein said wireless device includes a ringer, and wherein said disabling disables operation of said ringer.

8. The method of claim 1, wherein said wireless device includes a text messaging feature and wherein said disabling disables said text messaging feature.

9. The method of claim 1, wherein said wireless device determines said location, and further comprising transmitting said location to another device in said wireless network, and wherein said determining said location comprises receiving said location.

10. A wireless network control system for controlling a wireless network, said control system including a memory for storing program instructions and data, and a processor for executing said program instructions, and wherein said program instructions comprise program instructions for:
determining a location of a wireless device coupled to said wireless network;
second determining whether or not said location is within a controlled area, said controlled area being a geographical area designated for which use of a feature of said wireless device is not allowed; and
responsive to determining that said location is within said controlled area, disabling said feature of said wireless device.

11. The wireless network control system of method of claim 10, wherein said wireless device includes a camera, and wherein said program instructions for disabling send a command to said wireless device to disable operation of said camera.

12. The wireless network control system of claim 10, further comprising program instructions for third determining said feature in conformity with a result of said second determining.

13. The wireless network control system of claim 10, wherein said program instructions for second determining further determine whether or not said feature is a feature controlled locally within said wireless device, and wherein said program instructions for disabling comprise program instructions for:
sending a command to said wireless device from said wireless network in response to determining that said feature is controlled locally; and
disabling said feature within said wireless device in response to said command.

14. The wireless network control system of claim 10, wherein said program instructions for second determining further determine whether or not said feature is a feature provided by a service of said wireless network, and wherein said program instructions for disabling comprise program instructions for suspending said service in response to determining that said feature is provided by said service.

15. The wireless network control system of claim 10, wherein-said program instructions further comprise program instructions for:
subsequent to said disabling, determining whether or not said wireless device has left said controlled area; and
responsive to determining that said wireless device has left said controlled area, enabling said feature of said wireless device.

16. The wireless network control system of claim 10, wherein said wireless device includes a ringer, and wherein said program instructions for disabling send a command to disable operation of said ringer.

17. The wireless network control system of claim 10, wherein said wireless device includes a text messaging feature and wherein said program instructions for disabling disable said text messaging feature.

18. The wireless network control system of claim 10, wherein said wireless device determines said location and transmits said location to said wireless network control system another, and wherein said program instructions for determining said location comprise instructions for receiving said location.

19. A wireless device for connection to a wireless network providing services to said wireless device, said wireless device comprising:
a processor for executing program instructions providing features of said wireless device in conjunction with said services; and
a memory for storing said program instructions coupled to said processor, and wherein said program instructions comprise program instructions for receiving a command from said wireless network, said command commanding disabling of a feature of said wireless device, whereby said feature may be disabled by said network in conformity with a determination that said wireless device is located in a controlled area, said controlled area being a geographical area designated for which use of said feature of said wireless device is not allowed.

20. The wireless device of claim 19, further comprising a camera coupled to said processor for capturing visual images in the vicinity of said wireless device, wherein said controlled area is an area designated for no photographic equipment use, and wherein said processor disables said camera in response to receiving said command.

21. A computer program product comprising signal-bearing media encoding program instructions for execution by a processor within a wireless network control system for controlling a wireless network, said control system including a memory for storing said program instructions, and wherein said program instructions comprise program instructions for:
determining a location of a wireless device coupled to said wireless network;
second determining whether or not said location is within a controlled area, said controlled area being a geographical area designated for which use of a feature of said wireless device is not allowed; and
responsive to determining that said location is within said controlled area, disabling said feature of said wireless device.

22. The computer program product of claim 21, wherein said wireless device includes a camera, and wherein said program instructions for disabling disable operation of said camera.

23. The computer program product of claim 21, wherein said program instructions for disabling send a command to said wireless device to disable operation of said feature.

24. The computer program product of claim 21, wherein said program instructions for disabling suspend a service of said wireless network that provides said feature.
